(19) United States
(12) Patent Application Publication
(10) Pub. No.: US 2025/0001525 A1
(43) Pub. Date: Jan. 2, 2025

(54) LASER CUTTING METHOD AND LASER CUTTING MACHINE

(71) Applicant: TRUMPF Werkzeugmaschinen SE + Co. KG, Ditzingen (DE)

(72) Inventors: David Schindhelm, Stuttgart (DE); Steffen Keßler, Stuttgart (DE); Winfried Magg, Ditzingen (DE); Alexander Schmid, Gärtringen (DE); Jan Schuster, Allmersbach im Tal (DE); Manuel Geiger, Möglingen (DE)

(21) Appl. No.: 18/806,738

(22) Filed: Aug. 16, 2024

Related U.S. Application Data
(63) Continuation of application No. PCT/EP2023/050679, filed on Jan. 13, 2023.

(30) Foreign Application Priority Data
Feb. 17, 2022 (DE) 10 2022 103 745.2

(51) Int. Cl. B23K 26/38

(52) U.S. Cl. CPC B23K 26/38

(57) ABSTRACT

A laser cutting method using a laser cutting machine includes a) cutting a workpiece using a laser cutting beam having a high power along a cutting line, b) scanning the cutting line on the workpiece using a laser scanning beam having a low power or using an illumination beam, and recording scanning data, c) changing at least one parameter of a plurality of parameters the laser cutting machine, repeating steps a) and b), and evaluating the scanning data with respect to the plurality of parameters of the laser cutting machine in a control device. The scanning of the cutting line on the workpiece using the laser scanning beam of the low power is carried out during a return travel of a laser machining head.

### CROSS REFERENCE TO RELATED APPLICATIONS

This application is a continuation of International Application No. PCT/EP2023/050679 (WO 2023/156090 A1), filed on Jan. 13, 2023, and claims benefit to German Patent Application No. DE 10 2022 103 745.2, filed on Feb. 17, 2022. The aforementioned applications are hereby incorporated by reference herein.

### FIELD

Embodiments of the present invention relate to a laser cutting method, a laser cutting machine, and a computer program product.

### BACKGROUND

The technical area of industrial cutting of various materials by means of laser radiation is increasingly gaining importance. Laser radiation from a laser cutting machine at high power, usually in the range of multiple kilowatts, is used in cutting workpieces made of different materials. In exceptional cases, it can occur that a workpiece is not cut through completely and the part to be severed remains on the workpiece. An incomplete cut through the workpiece, which does not result in severing of the workpiece along the cutting line or cutting gap, is referred to as a miscut. A miscut is usually determined by the machine operator in a further method step and the flawed workpiece is fed to the laser cutting machine for renewed cutting. A further possibility is known from document DE 102010039525 A1, in which a distance sensor is moved over the workpiece in the area of a breakthrough, wherein it is checked whether a complete breakthrough or severing cut is present. The workpiece is then fed to the laser cutting machine for renewed cutting.

### SUMMARY

Embodiments of the present invention provide a laser cutting method using a laser cutting machine. The method includes a) cutting a workpiece using a laser cutting beam having a high power along a cutting line, b) scanning the cutting line on the workpiece using a laser scanning beam having a low power or using an illumination beam, and recording scanning data, c) changing at least one parameter of a plurality of parameters the laser cutting machine, repeating steps a) and b), and evaluating the scanning data with respect to the plurality of parameters of the laser cutting machine in a control device. The scanning of the cutting line on the workpiece using the laser scanning beam of the low power is carried out during a return travel of a laser machining head.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a laser cutting machine according to some embodiments;

FIG. 2 shows a schematic side view of a sensor device having a control device of a laser cutting machine in the case of a workpiece processed using a laser beam of the laser cutting machine, according to some embodiments; and

FIG. 3 shows an exemplary signal profile of a signal of the sensor device, evaluated in the control device, of a cutting line having an area of a good cut and an area of a miscut, according to some embodiments.

### DETAILED DESCRIPTION

Embodiments of the invention provide an improved laser cutting method and an improved laser cutting machine.

A laser cutting method having the following method steps is provided for this purpose:
a. cutting a workpiece using a laser cutting beam having high power along a cutting line;
b. determining a good cut or miscut of the workpiece during the cutting of the workpiece;
c. scanning the cutting line on the workpiece using a laser scanning beam of low power or using an illumination beam and recording scanning data;
d. changing at least one parameter of the laser cutting machine;
repeating method steps a. to c.; and
evaluating the scanning data with respect to the various parameters of the laser cutting machine in a control device;
   wherein the scanning of the cutting line on the workpiece using the laser scanning beam of low power is carried out during a return travel of a laser machining head.

Furthermore, a laser cutting machine is provided for cutting a workpiece along a cutting line having at least one laser source for generating a laser cutting beam at high power, a camera for detecting a good cut or miscut of the workpiece during the cutting of the workpiece, a laser scanning beam of low power from the laser source or an illumination beam of an illumination unit, having a control device which is designed to change at least one parameter of the laser cutting machine and evaluate scanning data of the laser scanning beam of low power or the illumination beam with respect to the various parameters of the laser cutting machine.

Furthermore, a computer program product in a control device for carrying out the method is provided.

In one example, a good cut or miscut is determined during the cutting of the workpiece using a camera. In this way, a miscut can be reliably identified in real time.

In a further example, the method step of evaluating comprises determining positions of a miscut. The method step of cutting the workpiece using the laser cutting beam at high power is then carried out at the determined positions of the miscut. A position determination of the miscut on the workpiece is useful, on the one hand, when setting parameters of the laser cutting machine in order to achieve an improved cutting result. On the other hand, a miscut is eliminated by a targeted actuation of the laser cutting beam at high power exclusively at the positions of the workpiece which are not cut through, by which the miscut is eliminated in an economical manner.

A further example describes the following method steps
classifying the scanning data recorded using various parameters as a good cut or a miscut;
feeding the scanning data classified as a good cut or a miscut into the control device;
setting at least one of the parameters classified as a good cut on the laser cutting machine by way of the control device. These method steps enable improved parameter setting of the laser cutting machine in an automated manner. As a result of these method steps, the laser cutting machine will have a significantly lower risk of miscuts in operation.

After identifying a miscut, the cutting line on the workpiece is scanned using the laser scanning beam of low power, specifically during the return travel of a laser machining head for cutting the workpiece using the laser cutting beam at high power. On the one hand, it is determined quickly by means of the scan whether a miscut is present or the miscut was incorrectly identified. On the other hand, the length and the extent of the miscut are determined by means of the scan.

In a further example, at least one parameter of the laser cutting machine is changed from the selection of focal position, laser power of the laser cutting machine, focus diameter, the distance between a laser nozzle and the workpiece, a feed speed of the workpiece, and/or a gas pressure of a protective gas. The cutting result of the laser cutting machine is changed by changing or adapting at least one of the mentioned parameters.

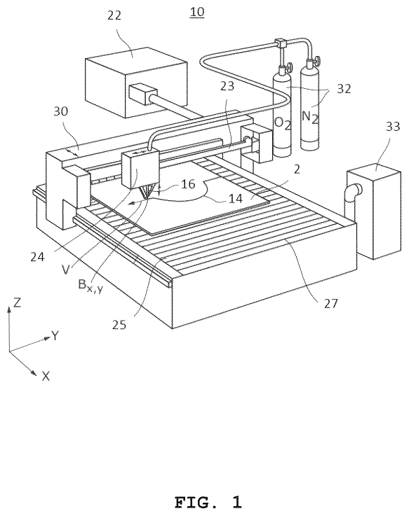

FIG. 1 shows a schematic representation of a laser cutting machine 10 having a laser source 22, a laser machining head 24, and a workpiece support 25. A solid-state laser is preferably used as the laser source 22, wherein the laser radiation is supplied via a laser light cable to the laser machining head 24. A laser cutting beam 16 at high power generated by the laser source 22 is guided by means of a beam guide 23 to the laser machining head 24 and focused therein and also aligned with the aid of mirrors perpendicular to the surface of a workpiece 2. A high power typically describes powers in the order of magnitude of multiple kilowatts in this case. The beam axis, the optical axis, of the laser cutting beam 16 therefore extends perpendicularly to the workpiece 2 in this example. In the example shown, the laser source 22 is a CO₂ laser source. Alternatively, the laser cutting beam 16 can be generated, for example, by a solid-state laser having a corresponding laser source. In a similar manner, a laser scanning beam of low power is generated and guided to the workpiece 2. A low power typically describes powers in the order of magnitude of multiple watts or several hundred milliwatts in this case. The laser cutting beam 16 and the laser scanning beam can be provided by the laser source 22 by setting the power thereon.

The laser cutting beam 16 is moved over the workpiece 2, so that a continuous kerf or cutting line 14 results, at which the workpiece 2 is usually completely cut through along the laser cutting beam 16.

The laser cutting can be assisted by adding a gas. Oxygen, nitrogen, compressed air, and/or application-specific gases can be used as the cutting gases, which are provided in connected cutting gas containers 32. Arising particles and gases can be suctioned from a suction chamber (not depicted here) located below the workpiece support 25 with the aid of a suction device 33.

The laser machining head 24 and the workpiece 2 are moved relative to one another in the laser cutting machine 1. In the example shown, the workpiece 2 rests on the workpiece support 25 during the machining, and the laser machining head 24 is moved along three axes X, Y, Z of an XYZ-coordinate system during the machining. A drive is provided for this purpose, which moves a gantry 30 displaceable in the X direction as indicated by a double arrow. The gantry 30 designates a displaceable frame on the laser cutting machine 10, as shown by way of example in FIG. 1. The laser machining head 24 can be displaced in the Y-direction with the aid of a further drive, indicated by a double-headed arrow, in order to be moved to any desired machining positions B_{X,Y} in the X-direction and Y-direction in a work field which is specified by the displaceability of the laser machining head 24 or by the workpiece 2. At a respective machining position B_{X,Y}, the laser cutting beam 16 has a feed direction V, which corresponds to the relative velocity between the laser machining head 24 and the workpiece 2. The feed direction V is represented by an arrow on the workpiece 2 in FIG. 1. The laser machining head 24 is moreover moved in the Z direction, usually during the reset or return travel or approach to cutting positions of the laser machining head 24.

The laser machining head 24 furthermore comprises a sensor device 1 as described hereinafter.

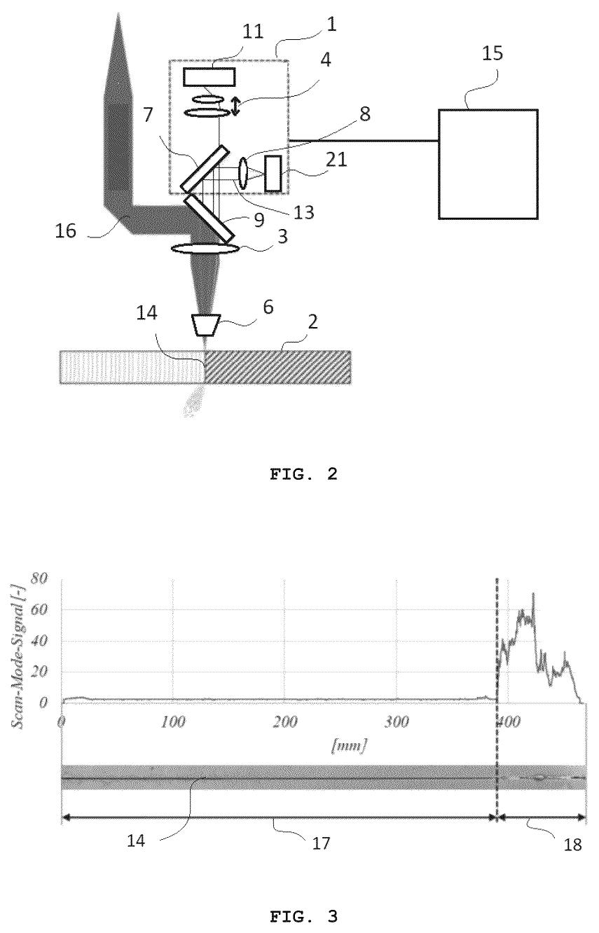

FIG. 2 shows a schematic side view of a sensor device 1 having a control device 15 connected for signaling. In this example, the laser machining head 24 comprises the sensor device 1. In this example, the sensor device 1 comprises an illumination unit 21 for generating and emitting in a targeted manner an illumination beam 13 through an optical element 8 to a suitable mirror 7. The mirror 7 guides the illumination beam 13 from the sensor device 1 through a dichroic deflection mirror 9, a focusing lens 3, and a cutting gas nozzle 6 to a machining area of the workpiece 2. The laser machining head 24 comprises the cutting gas nozzle 6. The illumination beam 13 is reflected at the workpiece 2 and the reflected illumination beam 13 takes the same path back and passes through the mirror 7 in order to be recorded by a camera 11. Alternatively to the camera 11, photodiodes can be provided, which capture the reflected illumination beam 13. In this way, images of the machining area on the workpiece 2 are recorded by the camera 11 or by photodiodes, wherein the machining area essentially contains a cutting line 14, produced by the laser cutting beam 16, with the adjacent workpiece sections. The cutting line 14 is accordingly passed over or scanned and scanning data are recorded. The laser cutting beam 16 is supplied in the laser machining head 24 via the deflection mirror 9 through the focusing lens 3 and the cutting gas nozzle 6, from which the laser cutting beam 16 having high energy exits from the laser machining head 24, is incident on the workpiece 2, and completely cuts through the workpiece 2 in a known manner. In an alternative embodiment, the sensor device 1 does not comprise an illumination unit 21 or an optical element 8. In this embodiment, the cutting line 14 is passed over or scanned with adjacent areas on the workpiece 2 by a laser scanning beam of low power. The laser scanning beam of low power can be generated in the laser source 22, in which the laser cutting beam 16 of high power is also generated. The laser source 22 then switches from a mode of cutting using high power to a scanning mode using low power. In this alternative, the cutting and the scanning on the workpiece 2 are accordingly executed in succession. In particular, in this embodiment the scanning of the cutting line 14 on the workpiece 2 using the laser scanning beam of low power is carried out during a return travel of the laser machining head 24. Firstly, the workpiece 2 is cut using high power, then a switch is made to low power, wherein the laser machining head 24 travels back along the cut route at the cutting line 14 and scans the cutting line 14 at the same time.

The laser machining head 24 travels back along the same route which it has covered, typically when a miscut 18 is detected. The laser machining head 24 is stopped, the laser source 22 is set by the control device 15 to a low power, so that a laser scanning beam can be provided. The laser scanning beam then scans the cutting line 14, and scanning data are recorded and evaluated as described. It is determined from the scanning data whether a miscut 18 is present or not. In other words, it is determined whether a miscut detection, the determination of the miscut 18, which causes the stopping of the laser machining head 24, has taken place correctly. Erroneous determination of a miscut 18 is precluded using these means. In particular, it can be determined quickly whether a miscut 18 is actually present, since the courses of movement of the laser machining head 24 are optimized. It is no longer necessary to move the laser machining head 24 to a starting point to scan the cutting line 14 after a flaw detection. Moreover, the position of the miscut 18 is determined, after which the laser machining head 24 approaches the position or positions of the miscut 18 with pinpoint precision in the mode of cutting and cuts through the workpiece 2 by renewed cutting. The laser machining head 24 covers the shortest possible route in this case, during scanning and during cutting. Unnecessary power losses due to cutting at incorrect positions are avoided, the workpiece 2 is not heated unnecessarily, and the quality of the cutting result on the workpiece 2 is not unnecessarily impaired. Repeated cutting can result in inadequate cutting results.

FIG. 3 shows an exemplary signal profile of a signal of the sensor device 1 evaluated in the control device 15 in the upper area of FIG. 3 and an associated cutting line 14 in the lower area of FIG. 3. The cutting line 14 is indicated with numeric specifications in the range of millimetres mm on the horizontal axis. The signals are generated by the photodiodes or the camera 11 using suitable image processing software. The camera 11 typically records the light intensity of a process light at the cutting line 14 in this case, which arises during laser welding upon the interaction of the laser beam with the material of the workpiece 2. It can be seen that the signal largely extends in the vicinity of the zero line. The associated cutting line 14 on the workpiece 2 extends without flaws, so that the workpiece 2 is completely cut through and only as much material is removed as is required to cut through or sever the workpiece 2. The area on the workpiece 2 associated with the low signal is designated as the good cut 17. To check whether there is an appearance of light during scanning and to categorize the images, on the one hand, as severing cut or good cut and, on the other hand, as incomplete cutting action or miscut, the maximum brightness is used in the area of the kerf of the cutting line 14. A threshold value is defined in the diagram according to FIG. 2 for this categorization. If an intensity feature, the maximum brightness in the area of the kerf of the cutting line 14, is below the threshold value, the image is classified as a good cut; if the intensity feature is above the threshold value, the image generated by the camera 11 is categorized or classified as a miscut. The signal of the light intensity is designated in this case as the scanning mode signal.

It can be seen on the right side of FIG. 3 that the cutting line 14 is disturbed and interrupted; an undesired miscut 18 has occurred in this case. In the signal profile, the area on the workpiece 2 of a miscut 18 results in a significant signal increase, recognizable on the signal to the right of the dashed line in FIG. 3. This signal increase is identified above a threshold value of a light intensity by the control device 15. As described, a good cut 17 or a miscut 18 of the workpiece 2 is determined during the cutting of the workpiece 2 and the cutting line 14 on the workpiece 2 can be scanned in different ways, wherein the cutting data and the scanning data are recorded. In the example according to FIG. 3, a miscut 18 occurs as described. Parameters of the laser cutting machine 10 are stored in the control device 15, for example the focal position, a laser power of the laser cutting machine 10, the focus diameter, the distance between a laser nozzle, in this case the cutting gas nozzle 6, and the workpiece 2, a feed speed of the laser machining head 24, and a gas pressure of a protective gas. Further parameters of the laser cutting machine 10 can be stored in the control device 15. The parameters or the parameter set of the laser cutting machine 10 are known for the example of FIG. 3 having the miscut 18. At least one parameter of the laser cutting machine 10 is then changed and the laser cutting method is repeated, the method steps of cutting, scanning, recording, and evaluating the scanning data being executed using the at least one changed parameter, as described. A good cut 17 or miscut 18 can be determined again using the at least one changed parameter, wherein the corresponding parameters or the parameter set is assigned to the good cut 17 or miscut. The above method steps are repeated as often as desired, so that a plurality of parameter sets is present in the control device 15 and it is known of each parameter set whether a good cut 17 or a miscut 18 is achieved using the parameter set and in which section in the cutting line 14 the good cut 17 and the miscut 18 are present. For example, after each cutting process, the parameter of the feed speed of the laser machining head 24 is changed. The cutting process with capturing or recording of scanning data at the changed feed speed is repeated until a miscut is recognized. Accordingly, the feed speed of the laser machining head 24, at which a miscut occurs, is known in the control device 15. The laser cutting machine 10 can be set in such a way that the parameter of the feed speed does not exceed the threshold value, at which a miscut occurs.

The scanning data with respect to the various parameters or parameter sets of the laser cutting machine 10 are evaluated in the control device 15 using suitable software. For example, parameters or parameter sets can be assigned to a good cut 17, while other parameters or parameters sets are assigned to a miscut 18. The scanning data recorded using different parameters are classified as a good cut 17 or a miscut 18 and stored. In this way, classes of parameters or parameter sets, which are assigned to good cuts 17, and classes, which are assigned to miscuts 18, are present in the control device 15. In addition, the data of the positions of the areas which are not cut through are assigned to the classes of miscuts 18. In principle, the parameters which result in a good cut 17 are automatically set or adjusted on the laser cutting machine 10. In this way, the laser cutting machine 10 is substantially kept in an operating state which enables good cuts 17 and avoids miscuts 18. The laser cutting machine 10 is so to speak trained in this way. Furthermore, the classified data sets can be used to train a machine learning model.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 sensor device
2 workpiece
3 focusing lens
4 focusing device
6 cutting gas nozzle
7 mirror
8 optical element
9 dichroic mirror
10 laser cutting machine
11 camera
13 illumination beam
14 cutting line
15 control device
16 laser cutting beam
17 good cut
18 miscut
21 illumination unit
22 laser source
23 beam guiding
24 laser machining head
25 workpiece support
27 support web
30 gantry
32 cutting gas container
33 suction device

1. A laser cutting method using a laser cutting machine, the method comprising:
a) cutting a workpiece using a laser cutting beam having a high power along a cutting line;
b) scanning the cutting line on the workpiece using a laser scanning beam having a low power or using an illumination beam, and recording scanning data;
c) changing at least one parameter of a plurality of parameters the laser cutting machine;
repeating steps a) and b); and
evaluating the scanning data with respect to the plurality of parameters of the laser cutting machine in a control device;
wherein the scanning of the cutting line on the workpiece using the laser scanning beam of the low power is carried out during a return travel of a laser machining head.

2. The laser cutting method according to claim 1, further comprising:
determining whether the cutting of the workpiece is a good cut or a miscut during the cutting of the workpiece using a camera.

3. The laser cutting method according to claim 2, wherein the evaluating the scanning data comprises:
determining positions of the miscut;
the method further comprising cutting the workpiece using the laser cutting beam having the high power at the determined positions of the miscut.

4. The laser cutting method according to claim 1, further comprising:
classifying the scanning data recorded using the plurality of parameters as a good cut or a miscut;
feeding the scanning data classified as the good cut or the miscut into the control device; and
setting at least one of the parameters classified as the good cut on the laser cutting machine via the control device.

5. The laser cutting method according to claim 1, further comprising:
changing at least one parameter of the plurality of parameters of the laser cutting machine, the at least one parameter comprises at least one of a focal position, a laser power of the laser cutting machine, a focus diameter, a distance between a laser nozzle and the workpiece, a feed speed of the laser machining head, or a gas pressure of a protective gas.

6. A laser cutting machine for cutting a workpiece along a cutting line, the laser cutting machine comprising:
at least one laser source for generating a laser cutting beam having a high power and/or a laser scanning beam of a low power, and/or an illumination unit for generating the laser scanning beam of the low power,
a camera for detecting a good cut or a miscut of the workpiece during the cutting of the workpiece, and
a control device configured to change at least one parameter of a plurality of parameters of the laser cutting machine and to evaluate scanning data of the laser scanning beam of the low power or the illumination beam with respect to the plurality of parameters of the laser cutting machine.

7. The laser cutting machine according to claim 6, wherein the control device is further configured to classify the scanning data recorded using the plurality of parameters as a good cut or a miscut and store the scanning data.

8. The laser cutting machine according to claim 6, wherein the control device is further configured to set at least one of the parameters classified as a good cut on the laser cutting machine

9. The laser cutting machine according to claim 6, wherein the control device is further configured to evaluate signals of the detector, and to set a power of the laser source to the high power for cutting the workpiece and/or to the low power for scanning the cutting line using the laser scanning beam.

10. The laser cutting machine according to claim 6, wherein the laser scanning beam having the low power comprises at least one pulsed laser beam or a continuous laser beam.

11. A non-transitory computer-readable medium having program steps stored thereon, the program steps, when executed by a computer processor in a control device, causing performance of a method according to claim 1.
